(19) United States
(12) Patent Application Publication
(10) Pub. No.: US 2021/0277337 A1
(43) Pub. Date: Sep. 9, 2021

(54) Use Of Water Soluble Films Including Glucose And Fructose To Increase Stability Of Unit Dose Pacs

(71) Applicant: Henkel IP & Holding GmbH, Duesseldorf (DE)

(72) Inventor: Daniel Thomas Piorkowski, Fairfield, CT (US)

(73) Assignee: Henkel IP & Holding GmbH, Duesseldorf (DE)

(21) Appl. No.: 16/811,562

(22) Filed: Mar. 6, 2020

(51) Int. Cl. C11D 17/04; C11D 3/20; C11D 3/22; C11D 3/37; C08L 29/04; C08K 5/053; C08K 5/1545; C08K 5/1535

(52) U.S. Cl. CPC C11D 17/042; C11D 3/2065; C11D 3/2044; C11D 3/22; C11D 3/2068; C08L 2203/16; C08L 29/04; C08K 5/053; C08K 5/1545; C08K 5/1535; C11D 3/3707

(57) ABSTRACT

A unit detergent pack consists of a pouch made of a water-soluble film comprising polyvinyl alcohol, about 0.9 to about 15 weight percent actives of propylene glycol based on a total weight of the film, about 0 to about 23 weight percent actives of glycerin based on a total weight of the film, about 3 to about 17 weight percent actives of polyethylene glycol based on a total weight of the film wherein the polyethylene glycol has a number-average molecular weight of about 100 Daltons to about 600 Daltons, about 4 to about 15 weight percent actives of glucose based on a total weight of the film, and about 8 to about 18 weight percent actives of fructose based on a total weight of the film. The pack also includes a detergent composition encapsulated within the pouch.

### FIELD OF THE INVENTION

The present disclosure generally relates to a unit dose detergent pack that consists of a pack made of a water-soluble film and a detergent composition disposed therein. The water-soluble film includes glucose and fructose which leads to increased pack stability.

### BACKGROUND OF THE INVENTION

The inclusion of high levels of water or solvent in unit dose detergent packs that include water soluble films causes many issues including poor pack haptics, hydrolysis of acetate esters in the films which leads to poor solubility, and loss of pack weight over time due to transpiration of water through the film.

In some cases, water or solvents from detergent compositions migrate into the film causing loss of valuable film properties. In other cases, components of the film migrate out of the film and into the detergent compositions thereby also causing loss of valuable film properties but also potential issues with the efficacy of the detergent compositions themselves.

Accordingly, there remains an opportunity for improvement. Furthermore, other desirable features and characteristics of the present disclosure will become apparent from the subsequent detailed description of the disclosure and the appended claims, taken in conjunction this background of the disclosure.

### SUMMARY OF THE INVENTION

This disclosure provides a unit detergent pack consisting of a pouch made of a water-soluble film including polyvinyl alcohol, about 0.9 to about 15 weight percent actives of propylene glycol based on a total weight of the film, about 0 to about 23 weight percent actives of glycerin based on a total weight of the film, about 3 to about 17 weight percent actives of polyethylene glycol based on a total weight of the film wherein the polyethylene glycol has a number-average molecular weight of about 100 Daltons to about 600 Daltons, about 4 to about 15 weight percent actives of glucose based on a total weight of the film, and about 8 to about 18 weight percent actives of fructose based on a total weight of the film. The pack also includes a detergent composition encapsulated within the pouch and including about 0 to about 15 weight percent actives of propylene glycol based on a total weight of the detergent composition, about 0 to about 20 weight percent actives of glycerin based on a total weight of the detergent composition, about 5 to about 55 weight percent actives of high fructose corn syrup based on a total weight of the detergent composition, about 5 to about 30 weight percent actives of an alkoxylated alcohol based on a total weight of the detergent composition, about 0 to about 20 weight percent actives of an alcohol ethoxy sulfate having a C8-C20 backbone that is ethoxylated with from about 1 to about 10 moles of ethylene oxide based on a total weight of the detergent composition, about 8 to about 35 weight percent of water based on a total weight of the detergent composition, and about 0 to about 25 weight percent actives of polyethylene glycol based on a total weight of the detergent composition wherein the polyethylene glycol has a number-average molecular weight of about 100 Daltons to about 600 Daltons.

This disclosure also provides a method of forming a unit dose detergent pack consisting of a pouch made of a water-soluble film and a detergent composition encapsulated within the pouch. The method includes the steps of providing the aforementioned film, independently providing the detergent composition including high fructose corn syrup, an alkoxylated alcohol, and water, and optionally, propylene glycol, glycerin, an alcohol ethoxy sulfate, and/or polyethylene glycol, and disposing the detergent composition in the pouch to form the unit dose detergent pack.

This disclosure further provides the water-soluble film itself consisting essentially of; polyvinyl alcohol, about 0.9 to about 15 weight percent actives of propylene glycol based on a total weight of the film, about 0 to about 23 weight percent actives of glycerin based on a total weight of the film, about 3 to about 17 weight percent actives of polyethylene glycol based on a total weight of the film wherein the polyethylene glycol has a number-average molecular weight of about 100 Daltons to about 600 Daltons; about 4 to about 15 weight percent actives of glucose based on a total weight of the film, and about 8 to about 18 weight percent actives of fructose based on a total weight of the film.

This disclosure also provides a method for producing the water-soluble film including the steps of providing a first film including polyvinyl alcohol (PVOH); and exposing the first film to a mixture of solvents including propylene glycol, high fructose corn syrup, and polyethylene glycol.

The unit dose pack, detergent composition, and method exhibit superior and unexpected results. For example, inclusion of high fructose corn syrup in the detergent composition unexpectedly created packs that had improved dissolution over time versus traditional unit dose detergents that did not contain the high fructose corn syrup because glucose and fructose in the detergent composition migrated into the film thereby creating an unexpectedly robust film.

It was further discovered that the inclusion of high fructose corn syrup in the detergent composition caused the PVOH film to have a reduced concentration of glycerin (as compared to initial levels in the film). Moreover, and as first described above, the high fructose corn syrup became part of the film composition (from an initial level of zero) as glucose and fructose monosaccharides migrated into the film thereby creating an unexpectedly robust film.

It was also discovered that the high fructose corn syrup can be incorporated into the film through the diffusion of glucose and fructose from the detergent composition to the water-soluble film or can be included during the manufacturing of the water-soluble film itself. Both methods unexpectedly allow for a more stable product to be produced because the liquid and film are at equilibrium upon manufacturing instead of reaching equilibrium over time through the diffusion of components into and out of the film/liquid thereby leading to superior and unexpected pack stability.

### DETAILED DESCRIPTION OF THE INVENTION

The following detailed description is merely exemplary in nature and is not intended to limit the disclosure. Furthermore, there is no intention to be bound by any theory presented in the preceding background or the following detailed description.

Embodiments of the present disclosure are generally directed to detergent compositions and methods for forming the same. For the sake of brevity, conventional techniques related to detergent compositions may not be described in detail herein. Moreover, the various tasks and process steps described herein may be incorporated into a more comprehensive procedure or process having additional steps or functionality not described in detail herein. In particular, various steps in the manufacture of detergent compositions are well-known and so, in the interest of brevity, many conventional steps will only be mentioned briefly herein or will be omitted entirely without providing the well-known process details.

### Unit Dose Detergent Pack

This disclosure provides a unit dose detergent pack that includes a pouch made of a water-soluble film and a detergent composition encapsulated within the pouch.

A unit dose pack can be formed by encapsulating the detergent composition within the pouch, wherein the pouch includes a film. In some embodiments, the film forms one half or more of the pouch, where the pouch may also include dyes or other components. In some embodiments, the film is water soluble such that the film will completely dissolve when an exterior of the film is exposed to water, such as in a washing machine typically used for laundry. When the film dissolves, the pouch is ruptured, and the contents are released. As used herein, “water soluble” means at least 2 grams of the solute (the film in one example) will dissolve in 5 liters of solvent (water in one example,) for a solubility of at least 0.4 grams per liter (g/l), at a temperature of 25 degrees Celsius (° C.) unless otherwise specified. Suitable films for packaging are completely soluble in water at temperatures of about 5° C. or greater. In various embodiments, the film is desirably strong, flexible, shock resistant, and non-tacky during storage at both high and low temperatures and high and low humidities.

The unit dose pack may be formed from a pouch having a single section, but the unit dose pack may be formed from pouches with two or more different sections in alternate embodiments. In embodiments with a pouch having two or more sections, the contents of the different sections may or may not be the same. The film may have a thickness of from about 25 to about 200 microns (μm), or from about 45 to about 100 μm, or from about 70 to about 90 μm in various embodiments. The film may include additional materials in some embodiments, such as methyl hydroxy propyl cellulose and polyethylene oxide. In various non-limiting embodiments, all values and ranges of values, both whole and fractional, between and including all of the above, are hereby expressly contemplated for use herein.

In one embodiment, the film includes polyvinyl alcohol, about 0.9 to about 15 weight percent actives of propylene glycol based on a total weight of the film, about 0 to about 23 weight percent actives of glycerin based on a total weight of the film, about 3 to about 17 weight percent actives of polyethylene glycol based on a total weight of the film wherein the polyethylene glycol has a number-average molecular weight of about 100 Daltons to about 600 Daltons, about 4 to about 15 weight percent actives of glucose based on a total weight of the film, and about 8 to about 18 weight percent actives of fructose based on a total weight of the film. In various non-limiting embodiments, all values and ranges of values, both whole and fractional, between and including all of the above, are hereby expressly contemplated for use herein.

In another embodiment, the film consists essentially of polyvinyl alcohol, about 0.9 to about 15 weight percent actives of propylene glycol based on a total weight of the film, about 0 to about 23 weight percent actives of glycerin based on a total weight of the film, about 3 to about 17 weight percent actives of polyethylene glycol based on a total weight of the film wherein the polyethylene glycol has a number-average molecular weight of about 100 Daltons to about 600 Daltons, about 4 to about 15 weight percent actives of glucose based on a total weight of the film, and about 8 to about 18 weight percent actives of fructose based on a total weight of the film. In various non-limiting embodiments, all values and ranges of values, both whole and fractional, between and including all of the above, are hereby expressly contemplated for use herein.

In a further embodiment, the film consists of polyvinyl alcohol, about 0.9 to about 15 weight percent actives of propylene glycol based on a total weight of the film, about 0 to about 23 weight percent actives of glycerin based on a total weight of the film, about 3 to about 17 weight percent actives of polyethylene glycol based on a total weight of the film wherein the polyethylene glycol has a number-average molecular weight of about 100 Daltons to about 600 Daltons, about 4 to about 15 weight percent actives of glucose based on a total weight of the film, and about 8 to about 18 weight percent actives of fructose based on a total weight of the film. In various non-limiting embodiments, all values and ranges of values, both whole and fractional, between and including all of the above, are hereby expressly contemplated for use herein.

The film typically includes polyvinyl alcohol (PVOH) and may include a higher concentration of PVOH than polyvinyl acetate. In one embodiment, the film initially has about 85 percent of the acetate groups hydrolyzed to alcohol groups. Some of the acetate groups may further hydrolyze in use, so the final concentration of alcohol groups may be higher than the concentration at the time of packaging. The film may include the polyvinyl alcohol in an amount of from about 30 to about 85, about 35 to about 80, about 40 to about 75, about 45 to about 70, about 50 to about 65, about 55 to about 60, about 40 to about 85, about 55 to about 85, about 55 to about 77, about 55 to about 75, or about 55 to about 65, weight percent based on a total weight of the film. In various non-limiting embodiments, all values and ranges of values, both whole and fractional, between and including all of the above, are hereby expressly contemplated for use herein.

Relative to propylene glycol, the film also includes about 0.9 to about 15 weight percent actives of propylene glycol based on a total weight of the film. In various embodiments, the film includes from about 2 to about 14, about 3 to about 13, about 4 to about 12, about 5 to about 11, about 6 to about 10, about 7 to about 9, about 8 to about 9, or about 0.9, 1, 2, 3, 4, 5, 6, 7, 8, 9, 10, 11, 12, 13, 14, or 15, weight percent actives of propylene glycol based on a total weight of the film. In various non-limiting embodiments, all values and ranges of values, both whole and fractional, between and including all of the above, are hereby expressly contemplated for use herein.

Relative to glycerin, the film also includes about 0 to about 23 weight percent actives of glycerin based on a total weight of the film. In various embodiments, the film includes from about 1 to about 22, about 2 to about 21, about 3 to about 20, about 4 to about 19, about 5 to about 18, about 6 to about 17, about 7 to about 16, about 8 to about 15, about 9 to about 14, about 10 to about 13, about 11 to about 12 or about 1, 2, 3, 4, 5, 6, 7, 8, 9, 10, 11, 12, 13, 14, 15, 16, 17, 18, 19, 20, 21, 22, or 23, weight percent actives of glycerin based on a total weight of the film. In various non-limiting embodiments, all values and ranges of values, both whole and fractional, between and including all of the above, are hereby expressly contemplated for use herein.

Relative to polyethylene glycol, the film also includes about 3 to about 17 weight percent actives of polyethylene glycol based on a total weight of the film wherein the polyethylene glycol has a number-average molecular weight of about 100 Daltons to about 600 Daltons. In various embodiments, the film includes from about 4 to about 16, about 5 to about 15, about 6 to about 13, about 7 to about 12, about 8 to about 11, about 9 to about 10, or about 3, 4, 5, 6, 7, 8, 9, 10, 11, 12, 13, 14, 15, 16, or 17, weight percent actives of polyethylene glycol based on a total weight of the film. In addition, the polyethylene glycol has a number-average molecular weight of about 100 to about 600, about 200 to about 500, about 300 to about 400, or about 100, 200, 300, 400, 500, or 600, Daltons. In various non-limiting embodiments, all values and ranges of values, both whole and fractional, between and including all of the above, are hereby expressly contemplated for use herein.

Relative to glucose, the film further includes about 4 to about 15 weight percent actives of glucose based on a total weight of the film. In various embodiments, the film includes from about 5 to about 14, about 6 to about 13, about 7 to about 12, about 8 to about 11, about 9 to about 10, or about 4, 5, 6, 7, 8, 9, 10, 11, 12, 13, 14, or 15, weight percent actives of glucose based on a total weight of the film. In various non-limiting embodiments, all values and ranges of values, both whole and fractional, between and including all of the above, are hereby expressly contemplated for use herein.

Relative to fructose, the film further includes about 8 to about 18 weight percent actives of fructose based on a total weight of the film. In various embodiments, the film includes from about 9 to about 17, about 10 to about 16, about 11 to about 15, about 12 to about 14, about 13 to about 14, or about 8, 9, 10, 11, 12, 13, 14, 15, 16, 17, or 18, weight percent actives of fructose based on a total weight of the film. In various non-limiting embodiments, all values and ranges of values, both whole and fractional, between and including all of the above, are hereby expressly contemplated for use herein.

In one embodiment, the propylene glycol is present in the film in an amount of from about 0.9 to about 9 weight percent actives based on a total weight of the film; the glycerin is present in the film in an amount of from about 0 to about 19 weight percent actives based on a total weight of the film; the glucose is present in the film in an amount of from about 7 to 11 weight percent actives based on a total weight of the film; and the fructose is present in the film in an amount of from about 11 to about 15 weight percent actives based on a total weight of the film. In various non-limiting embodiments, all values and ranges of values, both whole and fractional, between and including all of the above, are hereby expressly contemplated for use herein.

In another embodiment, the propylene glycol is present in the film in an amount of from about 1 to about 5 weight percent actives based on a total weight of the film; the glycerin is present in the film in an amount of from about 0.1 to about 0.3 weight percent actives based on a total weight of the film; the glucose is present in the film in an amount of from about 7 to 11 weight percent actives based on a total weight of the film; and the fructose is present in the film in an amount of from about 11 to about 15 weight percent actives based on a total weight of the film. In various non-limiting embodiments, all values and ranges of values, both whole and fractional, between and including all of the above, are hereby expressly contemplated for use herein.

In a further embodiment, the propylene glycol is present in the film in an amount of about 3 weight percent actives based on a total weight of the film; the glycerin is present in the film in an amount of about 0.2 weight percent actives based on a total weight of the film; the glucose is present in the film in an amount of about 9 weight percent actives based on a total weight of the film; and the fructose is present in the film in an amount of about 13 weight percent actives based on a total weight of the film. In various non-limiting embodiments, all values and ranges of values, both whole and fractional, between and including all of the above, are hereby expressly contemplated for use herein.

In another embodiment, the water-soluble film consists essentially of the propylene glycol in an amount of from about 0.9 to about 9 weight percent actives based on a total weight of the film; the glycerin in an amount of from about 0 to about 19 weight percent actives based on a total weight of the film; the glucose in an amount of from about 7 to 11 weight percent actives based on a total weight of the film; the fructose in an amount of from about 11 to about 15 weight percent actives based on a total weight of the film; and the polyethylene glycol. In various non-limiting embodiments, all values and ranges of values, both whole and fractional, between and including all of the above, are hereby expressly contemplated for use herein.

### Detergent Composition

The pack also includes a detergent composition encapsulated within the pouch.

In one embodiment, the detergent composition includes high fructose corn syrup, an alkoxylated alcohol, and water, and optionally, propylene glycol, glycerin, an alcohol ethoxy sulfate, and/or polyethylene glycol.

In one embodiment, the detergent composition consists essentially of high fructose corn syrup, an alkoxylated alcohol, and water, and optionally, propylene glycol, glycerin, an alcohol ethoxy sulfate, and/or polyethylene glycol.

In one embodiment, the detergent composition consists of high fructose corn syrup, an alkoxylated alcohol, and water, and optionally, propylene glycol, glycerin, an alcohol ethoxy sulfate, and/or polyethylene glycol.

Any one or more of these components may be present in any amount as described throughout this disclosure. Moreover, the optional components may be included in an amount of greater than zero or the detergent composition may be free of one or more such components.

In one embodiment, the detergent composition includes about 0 to about 15 weight percent actives of propylene glycol based on a total weight of the detergent composition, about 0 to about 20 weight percent actives of glycerin based on a total weight of the detergent composition, about 5 to about 55 weight percent actives of high fructose corn syrup based on a total weight of the detergent composition, about 5 to about 30 weight percent actives of an alkoxylated alcohol based on a total weight of the detergent composition, about 0 to about 20 weight percent actives of an alcohol ethoxy sulfate having a C8-C20 backbone that is ethoxylated with from about 1 to about 10 moles of ethylene oxide based on a total weight of the detergent composition, about 8 to about 35 weight percent of water based on a total weight of the detergent composition, and about 0 to about 25 weight percent actives of polyethylene glycol based on a total weight of the detergent composition wherein the polyethylene glycol has a number-average molecular weight of about 100 Daltons to about 600 Daltons. In various non-limiting embodiments, all values and ranges of values, both whole and fractional, between and including all of the above, are hereby expressly contemplated for use herein.

In one embodiment, the detergent composition consists essentially of about 0 to about 15 weight percent actives of propylene glycol based on a total weight of the detergent composition, about 0 to about 20 weight percent actives of glycerin based on a total weight of the detergent composition, about 5 to about 55 weight percent actives of high fructose corn syrup based on a total weight of the detergent composition, about 5 to about 30 weight percent actives of an alkoxylated alcohol based on a total weight of the detergent composition, about 0 to about 20 weight percent actives of an alcohol ethoxy sulfate having a C8-C20 backbone that is ethoxylated with from about 1 to about 10 moles of ethylene oxide based on a total weight of the detergent composition, about 8 to about 35 weight percent of water based on a total weight of the detergent composition, and about 0 to about 25 weight percent actives of polyethylene glycol based on a total weight of the detergent composition wherein the polyethylene glycol has a number-average molecular weight of about 100 Daltons to about 600 Daltons. In various non-limiting embodiments, all values and ranges of values, both whole and fractional, between and including all of the above, are hereby expressly contemplated for use herein.

In another embodiment, the detergent composition consists of about 0 to about 15 weight percent actives of propylene glycol based on a total weight of the detergent composition, about 0 to about 20 weight percent actives of glycerin based on a total weight of the detergent composition, about 5 to about 55 weight percent actives of high fructose corn syrup based on a total weight of the detergent composition, about 5 to about 30 weight percent actives of an alkoxylated alcohol based on a total weight of the detergent composition, about 0 to about 20 weight percent actives of an alcohol ethoxy sulfate having a C8-C20 backbone that is ethoxylated with from about 1 to about 10 moles of ethylene oxide based on a total weight of the detergent composition, about 8 to about 35 weight percent of water based on a total weight of the detergent composition, and about 0 to about 25 weight percent actives of polyethylene glycol based on a total weight of the detergent composition wherein the polyethylene glycol has a number-average molecular weight of about 100 Daltons to about 600 Daltons. In various non-limiting embodiments, all values and ranges of values, both whole and fractional, between and including all of the above, are hereby expressly contemplated for use herein.

Relative to the propylene glycol, the detergent composition may include the propylene glycol in an amount of from about 0 to about 15, about 1 to about 14, about 2 to about 13, about 3 to about 12, about 4 to about 11, about 5 to about 10, about 6 to about 9, about 7 to about 8, weight percent actives of propylene glycol based on a total weight of the detergent composition. In various non-limiting embodiments, all values and ranges of values, both whole and fractional, between and including all of the above, are hereby expressly contemplated for use herein.

Relative to the glycerin, the detergent composition may include the glycerin in an amount of from about 0 to about 20, about 1 to about 19, about 2 to about 18, about 3 to about 17, about 4 to about 16, about 5 to about 15, about 6 to about 14, about 7 to about 13, about 8 to about 12, about 9 to about 11, or about 10 to about 11, weight percent actives of glycerin based on a total weight of the detergent composition. In various non-limiting embodiments, all values and ranges of values, both whole and fractional, between and including all of the above, are hereby expressly contemplated for use herein.

Relative to the high fructose corn syrup, the detergent composition may include the high fructose corn syrup in an amount of from about 5 to about 55, about 10 to about 50, about 15 to about 45, about 20 to about 40, about 25 to about 35, or about 30 to about 35, weight percent actives of high fructose corn syrup based on a total weight of the detergent composition. In various non-limiting embodiments, all values and ranges of values, both whole and fractional, between and including all of the above, are hereby expressly contemplated for use herein.

Relative to the alkoxylated alcohol, the detergent composition may include the alkoxylated alcohol in an amount of from about 5 to about 30, about 10 to about 25, or about 15 to about 20, weight percent actives of an alkoxylated alcohol based on a total weight of the detergent composition. In various non-limiting embodiments, all values and ranges of values, both whole and fractional, between and including all of the above, are hereby expressly contemplated for use herein.

Relative to the alcohol ethoxy sulfate, the detergent composition may include the alcohol ethoxy sulfate in an amount of about 0 to about 20, about 1 to about 19, about 2 to about 18, about 3 to about 17, about 4 to about 16, about 5 to about 15, about 6 to about 14, about 7 to about 13, about 8 to about 12, about 9 to about 11, or about 10 to about 11, weight percent actives of an alcohol ethoxy sulfate having a C₈-C₂₀ backbone that is ethoxylated with from about 1 to about 10 moles of ethylene oxide based on a total weight of the detergent composition. In various non-limiting embodiments, all values and ranges of values, both whole and fractional, between and including all of the above, are hereby expressly contemplated for use herein.

Relative to the water, the detergent composition may include the water in an amount of about 8 to about 35, about 10 to about 30, about 15 to about 25, about 20 to about 25, or about 8 to about 10, weight percent of water based on a total weight of the detergent composition. In various non-limiting embodiments, all values and ranges of values, both whole and fractional, between and including all of the above, are hereby expressly contemplated for use herein.

Relative to the polyethylene glycol, the detergent composition may include the high polyethylene glycol in an amount of about 0 to about 25, about 1 to about 24, about 2 to about 23, about 3 to about 22, about 4 to about 21, about 5 to about 20, about 6 to about 19, about 7 to about 18, about 8 to about 17, about 9 to about 16, about 10 to about 15, about 11 to about 14, or about 12 to about 13, weight percent actives of polyethylene glycol based on a total weight of the detergent composition wherein the polyethylene glycol has a number-average molecular weight of about 100 Daltons to about 600 Daltons. In various non-limiting embodiments, all values and ranges of values, both whole and fractional, between and including all of the above, are hereby expressly contemplated for use herein.

### Components of the Film and/or Detergent Composition

Each of the components of the film and/or detergent composition may be any known in the art. Moreover, the components of the film and/or detergent composition, even though of the same chemical genus or name, may be the same as each other or may be different from each other. As just one example, the polyethylene glycol of the film may be the same or different than the polyethylene glycol of the detergent composition. The same is contemplated for all of the other components, independently, as well. Moreover, various embodiments of the components of the film and/or detergent composition are described below.

### High Fructose Corn Syrup

Referring back to the high fructose corn syrup (HFCS), it is not particularly limited and may be any known in the art. HFCS includes about 24 wt % water, about 5 to about 5 wt % glucose oligomers, and the balance of fructose and glucose. For example, the HFCS may be further defined as HFCS 42, HFCS 55, HFCS 65, HFCS 70, HFCS 90, or combinations thereof. The aforementioned numerical values refer to an approximate weight percent of fructose, e.g. HFCS 42 includes approximately 42 wt % fructose based on dry weight of solids. Any of these may be utilized in the instant disclosure. In one embodiment, the HFCS is HFCS42. In another embodiment, the HFCS is HFCS55 that includes approximately 55 wt % fructose based on dry weight of solids. Combinations of any of the above may also be used.

### Glucose

Glucose is a monosaccharide with five hydroxyl groups are arranged in a specific way along a six-carbon backbone. Glucose is usually present in solid form as a monohydrate with a closed pyran ring (dextrose hydrate). In aqueous solution, glucose can be present as an open-chain or as α- or β-pyranose. Relative to this disclosure, the glucose may be present in any known form or any isomer, e.g. open chain form, ring form, etc.

### Fructose

Fructose is a 6-carbon polyhydroxyketone. Crystalline fructose adopts a cyclic six-membered structure owing to the stability of its hemiketal and internal hydrogen-bonding. This form is d-fructopyranose. Fructose can exist as an equilibrium mixture of 70% fructopyranose and about 22% fructofuranose, as well as small amounts of three other forms, including an acyclic structure. Any known isomer or form of fructose may be utilized in this disclosure.

### Propylene Glycol

The compound is also known as (alpha) α-propylene glycol to distinguish it from the isomer propane-1,3-diol, known as (beta) β-propylene glycol. Propylene glycol is chiral. Commercial processes typically use the racemate. Any form of propylene glycol can be used in this disclosure.

### Glycerin

The glycerin (also known as glycerol or glycerine) may be any type or form known in the art relative to use in this disclosure.

### Alkoxylated Alcohol

The alkoxylated alcohol is not particularly limited and may be any known in the art. For example, the alkoxylated alcohol may be a C₈-C₂₀ alcohol that is capped with (or includes) approximately 2 to 12 moles of an alkylene oxide. In other embodiments, the alkoxylated alcohol may be an alcohol alkoxylate that has from 8 to 20, 10 to 18, 12 to 16, or 12 to 14, carbon atoms and is an ethoxylate, propoxylate, or butoxylate and is capped with an alkylene oxide, e.g. ethylene oxide, propylene oxide, or butylene oxide. The alkoxylated alcohol may be capped with varying numbers of moles of the alkylene oxide, e.g. about 2 to about 12, about 3 to about 11, about 4 to about 10, about 5 to about 9, about 6 to about 8, or about 7 to about 8, moles. In various non-limiting embodiments, all values and ranges thereof, both whole and fractional, between and including all of the above, are hereby expressly contemplated for use herein.

### Alcohol Ethoxy Sulfate

The alcohol ethoxy sulfate is not particularly limited and may be any known in the art. For example, the alcohol ethoxy sulfate may have a C₈-C₂₀ backbone that is ethoxylated with from about 1 to about 10 moles of ethylene oxide. The backbone may have any number of carbon atoms from 8 to 20, e.g. 10 to 18, 12 to 16, 12 to 14, 14 to 16, or 8, 9, 10, 11, 12, 13, 14, 15, 16, 17, 18, 19, or 20, carbon atoms. The backbone may be ethoxylated with from about 1 to about 10, about 2 to about 9, about 3 to about 8, about 4 to about 7, about 5 to about 6, or 1, 2, 3, 4, 5, 6, 7, 8, 9, or 10, moles of ethylene oxide. In various embodiments, the alcohol ethoxy sulfate is further defined as sodium laureth sulfate (SLES) having the formula: CH₃(CH₂)₁₀CH₂(OCH₂CH₂)ₙOSO₃Na wherein n is from about 1 to about 10. In another embodiment, the alcohol ethoxy sulfate is sodium laureth sulfate ethoxylated with about 2 to about 4 moles of ethylene oxide. In various non-limiting embodiments, all values and ranges of values, both whole and fractional, between and including all of the above, are hereby expressly contemplated herein.

In one embodiment, the alcohol ethoxy sulfate is sodium laureth sulfate ethoxylated with about 2 to about 4 moles of ethylene oxide and the alkoxylated alcohol is an ethoxylated alcohol including a C₈-C₂₀ backbone that is ethoxylated with from about 2 to about 12 moles of ethylene oxide.

### Water

Relative to all descriptions of water herein, each amount may be alternatively described as a “total amount.” Typically, the terminology “total amount” refers to a total amount of water present in the composition from all components, i.e., not simply water added independently from, for example, the surfactant component.

An independent source of water, such as DI water, may be used to dilute the composition. This water may be independent from any water present in the composition as originating from one or more components. In other words, the composition includes water originating from the components themselves. However, to further dilute the composition, the independent water source may be used.

### Polyethylene Glycol

The polyethylene glycol used herein may be of any type or geometry known in the art. For example, the polyethylene glycol may have a weight average molecular weight (Mw) of about 200, 300, 400, 600, 800, or combinations thereof. In other embodiments, the polyethylene glycol has a number-average molecular weight of about 100 Daltons to about 600 Daltons, e.g. 100, 200, 300, 400, 500, or 600, Daltons. In various non-limiting embodiments, all values and ranges thereof, both whole and fractional, between and including all of the above, are hereby expressly contemplated for use herein.

### Linear Alkylbenzene Sulfonate

The film and/or detergent composition may alternatively include, or be free of, a linear alkylbenzene sulfonate (LAS>The linear alkylbenzene sulfonate (LAS) may have a linear alkyl chain that has, e.g. 10 to 13 carbon atoms. These carbon atoms are present in approximately the following mole ratios C10:C11:C12:C13 is about 13:30:33:24 having an average carbon number of about 11.6 and a content of the most hydrophobic 2-phenyl isomers of about 18-29 wt %. The linear alkylbenzene sulfonate may be any known in the art. In one embodiment, the film and/or detergent composition is free of LAS. In another embodiment, the film and/or detergent composition includes from about 0 to about 5 weight percent of LAS based on a total weight of the film and/or detergent composition. In another embodiment, the film and/or detergent composition includes from about 0 to about 25 weight percent of LAS based on a total weight of the film and/or detergent composition. In still other embodiments, the film and/or detergent composition includes from about 5 to about 25 or about 10 to about 15, weight percent of LAS based on a total weight of the film and/or detergent composition. In various non-limiting embodiments, all values and ranges thereof, both whole and fractional, between and including all of the above, are hereby expressly contemplated for use herein.

### Additives

The film and/or composition may include one or more of the following additives or may be free of one or more of the following additives. For example, the film and/or composition may include one or more foam inhibitors (e.g. defoaming agents). Suitable foam inhibitors include, but are not limited to, fatty acids such as coconut fatty acids. The composition may include the foam inhibitor at an amount of from about 0 to about 10 weight percent, based on the total weight of the composition. In one embodiment, the composition includes a defoaming agent and a neutralization agent. In various non-limiting embodiments, all values and ranges thereof, both whole and fractional, between and including all of the above, are hereby expressly contemplated for use herein.

Bittering agents may optionally be added to hinder accidental ingestion of the composition. Bittering agents are compositions that taste bad, so children or others are discouraged from accidental ingestion. Exemplary bittering agents include denatonium benzoate, aloin, and others. Bittering agents may be present in the composition at an amount of from about 0 to about 1 weight percent, or an amount of from about 0 to about 0.5 weight percent, or an amount of from about 0 to about 0.1 weight percent in various embodiments, based on the total weight of the composition. In various non-limiting embodiments, all values and ranges thereof, both whole and fractional, between and including all of the above, are hereby expressly contemplated for use herein.

In other embodiments, additives may be or include neutralizers/pH adjustors just as monoethanolamine and the like, enzymes, optical brighteners, chelators, and combinations thereof. These additives may be chosen from any known in the art.

In one embodiment, the composition is free of, or includes less than 5, 4, 3, 2, 1, 0.5, or 0.1, weight percent of, a solvent other than water, e.g. an organic solvent, non-polar solvent, polar aprotic solvent, polar protic solvent, etc. and combinations thereof. In various non-limiting embodiments, all values and ranges thereof, both whole and fractional, between and including all of the above, are hereby expressly contemplated for use herein.

### Method of Forming a Unit Dose Detergent Pack

This disclosure also provides a method of forming a unit dose detergent pack consisting of a pouch made of a water-soluble film and a detergent composition encapsulated within the pouch. The method includes the steps of providing the aforementioned film, independently providing the detergent composition including high fructose corn syrup, an alkoxylated alcohol, and water, and optionally, propylene glycol, glycerin, an alcohol ethoxy sulfate, and/or polyethylene glycol, and disposing the detergent composition in the pouch to form the unit dose detergent pack.

The step of providing the film is typically described as providing the film that already includes the glucose and fructose before any contact with a detergent composition is made. In other words, in this step, the film is provided already “doped” with the glucose and fructose. As described in the Examples, this is believed to reduce migration of glucose and fructose from the detergent composition itself thereby strengthening the film and reducing degradation and changes of the detergent composition. After the doped film is contacted with the detergent composition, the content of the glucose and fructose already in the film is thought to decrease osmosis of the glucose and fructose into and out of the film.

### Method for Producing the Water-Soluble Film

This disclosure also provides a method for producing the water-soluble film including the steps of: providing a first film including polyvinyl alcohol (PVOH); and exposing the first film to a mixture of solvents including propylene glycol, high fructose corn syrup, and polyethylene glycol. The step of providing the first film is typically described as providing a film that does not include glucose, fructose, high fructose corn syrup, etc. It can be described as a virgin film. The first film may be any known in the art, such as the film set forth in the Examples.

The step of exposing the first film to the mixture of solvents typically occurs before the film is shaped into a pouch for the unit dose pack but may occur after. In one embodiment, the film is formed and doped with glucose and fructose before any contact with the detergent composition.

### Additional Embodiments

This disclosure further provides the water-soluble film itself consisting essentially of; polyvinyl alcohol, about 0.9 to about 15 weight percent actives of propylene glycol based on a total weight of the film, about 0 to about 23 weight percent actives of glycerin based on a total weight of the film, about 3 to about 17 weight percent actives of polyethylene glycol based on a total weight of the film wherein the polyethylene glycol has a number-average molecular weight of about 100 Daltons to about 600 Daltons; about 4 to about 15 weight percent actives of glucose based on a total weight of the film, and about 8 to about 18 weight percent actives of fructose based on a total weight of the film. In various non-limiting embodiments, all values and ranges thereof, both whole and fractional, between and including all of the above, are hereby expressly contemplated for use herein.

In one embodiment, the water-soluble film consists essentially of the propylene glycol in an amount of from about 0.9 to about 9 weight percent actives based on a total weight of the film; the glycerin in an amount of from about 0 to about 19 weight percent actives based on a total weight of the film; the glucose in an amount of from about 7 to 11 weight percent actives based on a total weight of the film; the fructose in an amount of from about 11 to about 15 weight percent actives based on a total weight of the film; and the polyethylene glycol; and

the detergent composition consists essentially of;
about 4 to about 6 weight percent actives of propylene glycol based on a total weight of the detergent composition,
about 0 to about 3 weight percent actives of glycerin based on a total weight of the detergent composition,
about 20 to about 25 weight percent actives of high fructose corn syrup based on a total weight of the detergent composition,
about 20 to about 25 weight percent actives of a C12-C15 alcohol ethoxylate that is capped with about 7 moles of ethylene oxide based on a total weight of the detergent composition,
about 14 to about 18 weight percent actives of an alcohol ethoxy sulfate having a C₈-C₂₀ backbone that is ethoxylated with from about 1 to about 10 moles of ethylene oxide based on a total weight of the detergent composition,
about 2 to about 10 weight percent of water based on a total weight of the detergent composition, and
about 10 to about 15 weight percent actives of polyethylene glycol based on a total weight of the detergent composition wherein the polyethylene glycol has a number-average molecular weight of about 400 Daltons.
   In various non-limiting embodiments, all values and ranges thereof, both whole and fractional, between and including all of the above, are hereby expressly contemplated for use herein.

In another embodiment, the water-soluble film consists essentially of the propylene glycol in an amount of about 3 weight percent actives based on a total weight of the film; the glycerin in an amount of about 0.2 weight percent actives based on a total weight of the film; the glucose in an amount of about 9 weight percent actives based on a total weight of the film; the fructose in an amount of about 13 weight percent actives based on a total weight of the film; and the polyethylene glycol.

In a further embodiment, the water-soluble film consists essentially of the propylene glycol in an amount of about 3 weight percent actives based on a total weight of the film; the glycerin in an amount of about 0.2 weight percent actives based on a total weight of the film; the glucose in an amount of about 9 weight percent actives based on a total weight of the film; the fructose in an amount of about 13 weight percent actives based on a total weight of the film; and the polyethylene glycol; and

the detergent composition consists essentially of;
about 4 to about 6 weight percent actives of propylene glycol based on a total weight of the detergent composition,
about 0 to about 3 weight percent actives of glycerin based on a total weight of the detergent composition,
about 20 to about 25 weight percent actives of high fructose corn syrup based on a total weight of the detergent composition,
about 20 to about 25 weight percent actives of a C12-C15 alcohol ethoxylate that is capped with about 7 moles of ethylene oxide based on a total weight of the detergent composition,
about 14 to about 18 weight percent actives of an alcohol ethoxy sulfate having a C₈-C₂₀ backbone that is ethoxylated with from about 1 to about 10 moles of ethylene oxide based on a total weight of the detergent composition,
about 2 to about 10 weight percent of water based on a total weight of the detergent composition, and
about 10 to about 15 weight percent actives of polyethylene glycol based on a total weight of the detergent composition wherein the polyethylene glycol has a number-average molecular weight of about 400 Daltons.
   In various non-limiting embodiments, all values and ranges thereof, both whole and fractional, between and including all of the above, are hereby expressly contemplated for use herein.

### EXAMPLES

### Example 1

The following detergent compositions are formed then then incorporated into unit dose packs by combining 20 grams of the detergent composition with PVOH film (M8720 film, 76 microns, by Monosol) using methods well known in the art of forming packs.

| | Comparative | Exemplary |
|---|---|---|
| | Composition 1 | Composition 1 |
| Material | % Weight Use-Level of Raw Material | |
| C12-C15 Alcohol Ethoxylate 7EO | 23.074 | 23.074 |
| Propylene Glycol | 8.206 | 5.016 |
| LAS | 5 | 0 |
| Neutralizers and Fatty Acids | 5.33 | 5.21 |
| DI Water | 4.567 | 3 |
| Sodium C12-C14 | 26 | 26 |
| Alcohol Ethoxysulfate 3EO (AES), | | |
| 60% Active | | |
| Performance Polymers, Chelators, | 8.675 | 3.7 |
| Enzymes, Fragrance Bittering | | |
| Agent and Optical Brightener | | |
| Glycerin | QS to 100 | 0 |
| PEG 400 | — | 11.22 |
| High Fructose Corn Syrup 55 | — | 22.78 |
| Total | 100 | 100 |

After formation, the packs were then stored at 105° F. and tested for dissolution at multiple time points. Dissolution was tested by placing 1 pack in 1 liter of water in a standard Tergotometer. Complete dissolution time of the pack and liquid was recorded. A value over 12 minutes is considered a failure.

| | Average Dissolution Times of Packs in Duplicate Runs | | | |
|---|---|---|---|---|
| | (Minutes:Seconds) | | | |
| | | Dissolution | Dissolution | Dissolution |
| | | Time | Time | Time |
| | Dissolution | 2 Weeks | 4 Weeks | 6 Weeks |
| | Time | Storage at | Storage at | Storage at |
| | Initial | 105° F. | 105° F. | 105° F. |
| Pack of | Pass | Pass | Fail | Fail |
| Comparative | 4:54 | 6:07 | 14:50 | 16:35 |
| Composition 1 | | | | |
| Pack of | Pass | Pass | Pass | Pass |
| Exemplary | 4:31 | 5:15 | 7:21 | 7:42 |
| Composition 1 | | | | |

This data demonstrates that the Composition 1 that includes HFCS 55 passed testing through 6 weeks, whereas the comparative formula failed the dissolution test after 4 weeks.

### Example 2

The following detergent composition (Exemplary Composition 2) was created and formed into packs as described above except that 17.5 grams of the Composition was used per pack.

| | | % weight use-level |
|---|---|---|
| | | of Raw Material |
| | % Activity of | Exemplary |
| Description | Active Component | Composition 2 |
| Water | 100 | 4 |
| 25-7 Alcohol Ethoxylate | 99.85 | 5 |
| Propylene Glycol | 100 | 5 |
| Bitrex | 25 | 0.05 |
| AES | 60 | 5 |
| 50% NaOH | 50 | 0.6 |
| Coconut Fatty Acid | 100 | 2 |
| PEG 400 | 100 | 39.175 |
| HFCS55 | 100 | 39.175 |
| Total | — | 100 |

25-7 Alcohol Ethoxylate is a C12-C15 Alcohol Ethoxylate that is capped with approximately 7 moles of ethylene oxide.

AES is sodium laureth sulfate ethoxylated with about 3 moles of ethylene oxide.

After formation, the packs were then aged at 75° F. for 3 months, then cut open to drain the liquid and to dry the film with lintless tissue. The dried film was then analyzed by Ion-Exclusion Chromatography (BioRad Aminex-87H column) at 30° C. with a mobile phase of 5 mM Sulfuric Acid, a flow rate of 0.8 ml/min, Injection Volume qf 40 microliters. The results of these analyses are set forth in the Table below.

The data set forth below shows that glucose and fructose were not present in the virgin film but migrated into the film over time from the liquid detergent.

| | Fructose/% | Glucose/% |
|---|---|---|
| High Fructose Corn Syrup 55 | 41.46 | 30.92 |
| (Raw Material) | | |
| Liquid Detergent | 16.15 | 12.07 |
| (Used To Make Packs With Virgin Film) | | |
| Film of this Disclosure | 12.83 | 8.82 |
| (Film on Top of Pack) | | |
| Film of this Disclosure | 13.7 | 9.72 |
| (Film on Bottom of Pack) | | |
| Virgin Film | 0 | 0 |

Based on the above, it is believed that the inclusion of glucose and fructose in the PVOH film is beneficial for dissolution of packs after aging. This data supports the superior and unexpected results associated with creating a PVOH film that contains glucose and fructose that can be utilized prior to pack formation such as in the method described herein such that the pack is almost at a liquid/film equilibrium after pack creation, instead of requiring the diffusion of materials in and out of the film to reach equilibrium. This will create the most stable packs for pack haptics and dissolution.

The data set forth above shows that inclusion of high fructose corn syrup to a unit dose detergent composition unexpectedly created packs that had improved dissolution over time versus traditional unit dose detergents that did not contain the high fructose corn syrup. It was further discovered that the inclusion of high fructose corn syrup in the unit dose composition caused the PVOH film to have a reduced concentration of glycerin (as compared to initial levels in the film) as well as the high fructose corn syrup becoming part of the film composition (from an initial level of zero) as glucose and fructose monosaccharides, as shown in the table above. Moreover, the high fructose corn syrup can be incorporated in the film through the diffusion of glucose and fructose from the detergent composition to the water-soluble film or can be included during the manufacturing of the water-soluble film itself. Both methods unexpectedly allow for a more stable product to be produced because the liquid and film will be at equilibrium upon manufacturing instead of reaching equilibrium over time through the diffusion of components into and out of the film/liquid thereby leading to superior and unexpected pack stability.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A unit dose detergent pack consisting of:
A. a pouch made of a water-soluble film comprising;
polyvinyl alcohol,
about 0.9 to about 15 weight percent actives of propylene glycol based on a total weight of said film,
about 0 to about 23 weight percent actives of glycerin based on a total weight of said film,
about 3 to about 17 weight percent actives of polyethylene glycol based on a total weight of said film wherein said polyethylene glycol has a number-average molecular weight of about 100 Daltons to about 600 Daltons,
about 4 to about 15 weight percent actives of glucose based on a total weight of said film, and
about 8 to about 18 weight percent actives of fructose based on a total weight of said film; and
B. a detergent composition encapsulated within said pouch and comprising;
about 0 to about 15 weight percent actives of propylene glycol based on a total weight of said detergent composition,
about 0 to about 20 weight percent actives of glycerin based on a total weight of said detergent composition,
about 5 to about 55 weight percent actives of high fructose corn syrup based on a total weight of said detergent composition,
about 5 to about 30 weight percent actives of an alkoxylated alcohol based on a total weight of said detergent composition,
about 0 to about 20 weight percent actives of an alcohol ethoxy sulfate having a C₈-C₂₀ backbone that is ethoxylated with from about 1 to about 10 moles of ethylene oxide based on a total weight of said detergent composition,
about 8 to about 35 weight percent of water based on a total weight of said detergent composition, and
about 0 to about 25 weight percent actives of polyethylene glycol based on a total weight of said detergent composition wherein said polyethylene glycol has a number-average molecular weight of about 100 Daltons to about 600 Daltons.

2. The unit dose detergent pack of claim 1 wherein said propylene glycol is present in said film in an amount of from about 0.9 to about 9 weight percent actives based on a total weight of said film; said glycerin is present in said film in an amount of from about 0 to about 19 weight percent actives based on a total weight of said film; said glucose is present in said film in an amount of from about 7 to 11 weight percent actives based on a total weight of said film; and said fructose is present in said film in an amount of from about 11 to about 15 weight percent actives based on a total weight of said film.

3. The unit dose detergent pack of claim 1 wherein said propylene glycol is present in said film in an amount of from about 1 to about 5 weight percent actives based on a total weight of said film; said glycerin is present in said film in an amount of from about 0.1 to about 0.3 weight percent actives based on a total weight of said film; said glucose is present in said film in an amount of from about 7 to 11 weight percent actives based on a total weight of said film; and said fructose is present in said film in an amount of from about 11 to about 15 weight percent actives based on a total weight of said film.

4. The unit dose detergent pack of claim 1 wherein said propylene glycol is present in said film in an amount of about 3 weight percent actives based on a total weight of said film; said glycerin is present in said film in an amount of about 0.2 weight percent actives based on a total weight of said film; said glucose is present in said film in an amount of about 9 weight percent actives based on a total weight of said film; and said fructose is present in said film in an amount of about 13 weight percent actives based on a total weight of said film.

5. The unit dose detergent pack of claim 1 wherein
said water-soluble film consists essentially of said propylene glycol in an amount of from about 0.9 to about 9 weight percent actives based on a total weight of said film; said glycerin in an amount of from about 0 to about 19 weight percent actives based on a total weight of said film; said glucose in an amount of from about 7 to 11 weight percent actives based on a total weight of said film; said fructose in an amount of from about 11 to about 15 weight percent actives based on a total weight of said film; and said polyethylene glycol.

6. The unit dose detergent pack of claim 1 wherein
said water-soluble film consists essentially of said propylene glycol in an amount of from about 0.9 to about 9 weight percent actives based on a total weight of said film; said glycerin in an amount of from about 0 to about 19 weight percent actives based on a total weight of said film; said glucose in an amount of from about 7 to 11 weight percent actives based on a total weight of said film; said fructose in an amount of from about 11 to about 15 weight percent actives based on a total weight of said film; and said polyethylene glycol; and
said detergent composition consists essentially of;
about 4 to about 6 weight percent actives of propylene glycol based on a total weight of said detergent composition,
about 0 to about 3 weight percent actives of glycerin based on a total weight of said detergent composition,
about 20 to about 25 weight percent actives of high fructose corn syrup based on a total weight of said detergent composition,
about 20 to about 25 weight percent actives of a C12-C15 alcohol ethoxylate that is capped with about 7 moles of ethylene oxide based on a total weight of said detergent composition,
about 14 to about 18 weight percent actives of an alcohol ethoxy sulfate having a C₈-C₂₀ backbone that is ethoxylated with from about 1 to about 10 moles of ethylene oxide based on a total weight of said detergent composition,
about 2 to about 10 weight percent of water based on a total weight of said detergent composition, and
about 10 to about 15 weight percent actives of polyethylene glycol based on a total weight of said detergent composition wherein said polyethylene glycol has a number-average molecular weight of about 400 Daltons.

7. The unit dose detergent pack of claim 1 wherein said water-soluble film consists essentially of said propylene glycol in an amount of about 3 weight percent actives based on a total weight of said film; said glycerin in an amount of about 0.2 weight percent actives based on a total weight of said film; said glucose in an amount of about 9 weight percent actives based on a total weight of said film; said fructose in an amount of about 13 weight percent actives based on a total weight of said film; and said polyethylene glycol.

8. The unit dose detergent pack of claim 1 wherein said water-soluble film consists essentially of said propylene glycol in an amount of about 3 weight percent actives based on a total weight of said film; said glycerin in an amount of about 0.2 weight percent actives based on a total weight of said film; said glucose in an amount of about 9 weight percent actives based on a total weight of said film; said fructose in an amount of about 13 weight percent actives based on a total weight of said film; and said polyethylene glycol; and
said detergent composition consists essentially of;
about 4 to about 6 weight percent actives of propylene glycol based on a total weight of said detergent composition,
about 0 to about 3 weight percent actives of glycerin based on a total weight of said detergent composition,
about 20 to about 25 weight percent actives of high fructose corn syrup based on a total weight of said detergent composition,
about 20 to about 25 weight percent actives of a C12-C15 alcohol ethoxylate that is capped with about 7 moles of ethylene oxide based on a total weight of said detergent composition,
about 14 to about 18 weight percent actives of an alcohol ethoxy sulfate having a C₈-C₂₀ backbone that is ethoxylated with from about 1 to about 10 moles of ethylene oxide based on a total weight of said detergent composition,
about 2 to about 10 weight percent of water based on a total weight of said detergent composition, and
about 10 to about 15 weight percent actives of polyethylene glycol based on a total weight of said detergent composition wherein said polyethylene glycol has a number-average molecular weight of about 400 Daltons.

9. The unit dose detergent pack of claim 1 wherein said polyethylene glycol has a number-average molecular weight of about 400 Daltons.

10. A method of forming a unit dose detergent pack consisting of a pouch made of a water-soluble film and a detergent composition encapsulated within the pouch, said method comprising the steps of:
I. providing the film comprising;
polyvinyl alcohol;
about 0.9 to about 15 weight percent actives of propylene glycol based on a total weight of said film;
about 0 to about 23 weight percent actives of glycerin based on a total weight of said film;
about 4 to about 15 weight percent actives of glucose based on a total weight of said film; and
about 8 to about 18 weight percent actives of fructose based on a total weight of said film;
II. independently providing the detergent composition comprising;
high fructose corn syrup,
an alkoxylated alcohol, and
water, and
optionally,
propylene glycol,
glycerin,
an alcohol ethoxy sulfate, and/or
polyethylene glycol; and
III. disposing the detergent composition in the pouch to form the unit dose detergent pack.

11. The method of claim 10 wherein the film further comprises about 3 to about 17 weight percent actives of polyethylene glycol based on a total weight of the film wherein the polyethylene glycol has a number-average molecular weight of about 100 Daltons to about 600 Daltons.

12. The method of claim 10 wherein the propylene glycol is present in the film in an amount of from about 0.9 to about 9 weight percent actives based on a total weight of the film; the glycerin is present in the film in an amount of from about 0 to about 19 weight percent actives based on a total weight of the film; the glucose is present in the film in an amount of from about 7 to 11 weight percent actives based on a total weight of the film; and the fructose is present in the film in an amount of from about 11 to about 15 weight percent actives based on a total weight of the film.

13. The method of claim 10 wherein the propylene glycol is present in the film in an amount of from about 0.9 to about 9 weight percent actives based on a total weight of the film; the glycerin is present in the film in an amount of from about 0 to about 19 weight percent actives based on a total weight of the film; the glucose is present in the film in an amount of from about 7 to 11 weight percent actives based on a total weight of the film; and the fructose is present in the film in an amount of from about 11 to about 15 weight percent actives based on a total weight of the film.

14. The method of claim 10 wherein the propylene glycol is present in the film in an amount of about 3 weight percent actives based on a total weight of the film; the glycerin is present in the film in an amount of about 0.2 weight percent actives based on a total weight of the film; the glucose is present in the film in an amount of about 9 weight percent actives based on a total weight of the film; and the fructose is present in the film in an amount of about 13 weight percent actives based on a total weight of the film.

15. The method of claim 10 wherein
the water-soluble film consists essentially of the propylene glycol in an amount of from about 0.9 to about 9 weight percent actives based on a total weight of the film; the glycerin in an amount of from about 0 to about 19 weight percent actives based on a total weight of the film; the glucose in an amount of from about 7 to 11 weight percent actives based on a total weight of the film; the fructose in an amount of from about 11 to about 15 weight percent actives based on a total weight of the film; and the polyethylene glycol in an amount of from about 3 to about 17 weight percent actives based on a total weight of the film.

16. The method of claim 10 wherein
the water-soluble film consists essentially of the propylene glycol in an amount of from about 0.9 to about 9 weight percent actives based on a total weight of the film; the glycerin in an amount of from about 0 to about 19 weight percent actives based on a total weight of the film; the glucose in an amount of from about 7 to 11 weight percent actives based on a total weight of the film; the fructose in an amount of from about 11 to about 15 weight percent actives based on a total weight of the film; and the polyethylene glycol in an amount of from about 3 to about 17 weight percent actives based on a total weight of the film; and
the detergent composition consists essentially of;
about 4 to about 6 weight percent actives of propylene glycol based on a total weight of the detergent composition,
about 0 to about 3 weight percent actives of glycerin based on a total weight of the detergent composition,
about 20 to about 25 weight percent actives of high fructose corn syrup based on a total weight of the detergent composition,
about 20 to about 25 weight percent actives of a C12-C15 alcohol ethoxylate that is capped with about 7 moles of ethylene oxide based on a total weight of the detergent composition,
about 14 to about 18 weight percent actives of an alcohol ethoxy sulfate having a C₈-C₂₀ backbone that is ethoxylated with from about 1 to about 10 moles of ethylene oxide based on a total weight of the detergent composition,
about 2 to about 10 weight percent of water based on a total weight of the detergent composition, and
about 10 to about 15 weight percent actives of polyethylene glycol based on a total weight of the detergent composition wherein the polyethylene glycol has a number-average molecular weight of about 400 Daltons.

17. The method of claim 10 wherein the water-soluble film consists essentially of the propylene glycol in an amount of about 3 weight percent actives based on a total weight of the film; the glycerin in an amount of about 0.2 weight percent actives based on a total weight of the film; the glucose in an amount of about 9 weight percent actives based on a total weight of the film; the fructose in an amount of about 13 weight percent actives based on a total weight of the film; and polyethylene glycol in an amount of from about 3 to about 17 weight percent actives based on a total weight of the film.

18. The method of claim 10 wherein
the water-soluble film consists essentially of the propylene glycol in an amount of about 3 weight percent actives based on a total weight of the film; the glycerin in an amount of about 0.2 weight percent actives based on a total weight of the film; the glucose in an amount of about 9 weight percent actives based on a total weight of the film; the fructose in an amount of about 13 weight percent actives based on a total weight of the film; and polyethylene glycol in an amount of from about 3 to about 17 weight percent actives based on a total weight of the film; and
the detergent composition consists essentially of;
about 4 to about 6 weight percent actives of propylene glycol based on a total weight of the detergent composition,
about 0 to about 3 weight percent actives of glycerin based on a total weight of the detergent composition,
about 20 to about 25 weight percent actives of high fructose corn syrup based on a total weight of the detergent composition,
about 20 to about 25 weight percent actives of a C12-C15 alcohol ethoxylate that is capped with about 7 moles of ethylene oxide based on a total weight of the detergent composition,
about 14 to about 18 weight percent actives of an alcohol ethoxy sulfate having a C₈-C₂₀ backbone that is ethoxylated with from about 1 to about 10 moles of ethylene oxide based on a total weight of the detergent composition,
about 2 to about 10 weight percent of water based on a total weight of the detergent composition, and
about 10 to about 15 weight percent actives of polyethylene glycol based on a total weight of the detergent composition wherein the polyethylene glycol has a number-average molecular weight of about 400 Daltons.

19. A water-soluble film consisting essentially of;
polyvinyl alcohol,
about 0.9 to about 15 weight percent actives of propylene glycol based on a total weight of said film,
about 0 to about 23 weight percent actives of glycerin based on a total weight of said film,
about 3 to about 17 weight percent actives of polyethylene glycol based on a total weight of said film wherein said polyethylene glycol has a number-average molecular weight of about 100 Daltons to about 600 Daltons;
about 4 to about 15 weight percent actives of glucose based on a total weight of said film, and
about 8 to about 18 weight percent actives of fructose based on a total weight of said film

20. A method for producing the water-soluble film of claim 19, said method comprising the steps of:
providing a first film comprising polyvinyl alcohol (PVOH); and
exposing the first film to a mixture of solvents comprising propylene glycol, high fructose corn syrup, and polyethylene glycol.
